(19) United States
(12) Patent Application Publication
(10) Pub. No.: US 2009/0319192 A1
(43) Pub. Date: Dec. 24, 2009

(54) Measurement Facility, Sensor Unit and Further Processing Unit

(76) Inventors: Frank Bergner, Erlangen (DE); Nikolaus Demharter, Dormitz (DE); Michael Frank, Erlangen (DE); Sven Heggen, Erlangen (DE); Jurgen Rossler, Erlangen (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/487,033

(22) Filed: Jun. 18, 2009

(30) Foreign Application Priority Data
Jun. 19, 2008 (DE) 10 2008 029 189.7

(51) Int. Cl. G06F 19/00; G06F 15/00

(52) U.S. Cl. 702/19; 702/188

(57) ABSTRACT

A measurement facility comprises at least one sensor unit for measurement and issuing of signals and a further processing unit for receiving and further processing of signals which were measured by the at least one sensor unit, with an interface for detachable connection of the further processing unit to different sensor units. A further processing unit comprises at least one interface for establishing a detachable connection to a sensor unit, in order to form a usable inventive measurement facility. A sensor unit comprises a connection point for establishing the detachable connection to the further processing unit.

### CROSS REFERENCE TO RELATED APPLICATIONS

This application claims priority of German application No. 10 2008 029 189.7 filed Jun. 19, 2008, which is incorporated by reference herein in its entirety.

### FIELD OF THE INVENTION

The invention relates to a sensor unit for measurement and issuing of signals and to a further processing unit for receiving and further processing of signals as well as to a measurement facility.

### BACKGROUND OF THE INVENTION

In a large number of examinations with medical therapy or imaging devices, such as computer tomographs or magnetic resonance tomographs for example, a synchronization of the imaging with movements undertaken by the object under examination is necessary. In particular this applies to images of the heart or of examination objects moved along with the movement of the heart. For this synchronization for example either an EKG signal or the pulse of the patient to be examined is derived in order to trigger the imaging via the signals obtained in this way, e.g. at the R point of the EKG signal or at the maxima of the pulse curve. The same applies to examination objects which are moved by the breathing of the patient, and the imaging of which must therefore be synchronized with the breathing movement.

For each of these measurements a separate costly measurement facility, e.g. EKG measurement facility, pulse measurement facility or breathing movement measurement facility is needed. Each measurement facility must be stored in such cases at the customer ready for use in order to be able to be employed rapidly if necessary. However the storage of a number of measurement facilities occupies valuable space and involves costs for the storage of the measurement facilities.

### SUMMARY OF THE INVENTION

The object of the present invention is thus to specify a measurement facility as well as a sensor unit for measurement and issuing of signals and a further processing unit for receiving and further processing of signals which is of a space-saving design and can thus be stored at low cost.

The object is achieved by a measurement facility as well as by further processing unit and by a sensor unit according to the claims.

The invention is based on the knowledge that in each measurement facility the signals created by the respective sensors must first be edited before reaching a supervision unit. This editing of the signals is undertaken in each case in a specific further processing unit included in each measurement facility, which simultaneously occupies a majority of the total volume of the measurement facility.

An inventive measurement facility thus comprises at least one sensor unit for measurement and issuing of signals and a further processing unit for receiving and further processing of signals which are measured by at least the at least one sensor, with an interface for detachable connection of the further processing unit to different sensor units.

An inventive further processing unit thus comprises at least one interface for establishing a detachable connection to a sensor unit, in order to form a usable inventive measurement facility. And an inventive sensor unit comprises a connection point for establishing the detachable connection to the further processing unit.

Thus the space requirement for measurement facilities which measure different signals can be reduced in a simple manner by an inventive measurement facility and thereby costs saved for storage and provision of rooms. In addition the required outlay for development and service is reduced, since a separate further processing unit does not have to be developed for each measurement facility. The manufacturing costs can also be effectively reduced since fewer components will be needed.

At the same time the stock of spare parts to be held for the various measurement facilities is reduced, since spare parts are only needed for one further processing unit. The last point is especially advantageous in relation to energy supply units in the form of costly rechargeable batteries. In such cases just one charging station is also sufficient for an inventive further processing unit instead of one station for each unit.

Overall the use of inventive measurement facilities with a common inventive further processing unit can achieve a high level of flexibility, e.g. through the option of expanding a measurement facility by further connectable sensor units, with lower procurement costs than with separate individual measurement facilities and lower administrative overhead.

### BRIEF DESCRIPTION OF THE DRAWINGS

Further advantages and details of the present invention emerge from the exemplary embodiments described below as well as with reference to the drawings. The examples given do not represent any restriction of the invention. The drawings show:

FIG. 1 a schematic diagram of a typical inventive measurement facility,

FIGS. 2-7 examples of embodiment variants of an inventive further processing unit.

### DETAILED DESCRIPTION OF THE INVENTION

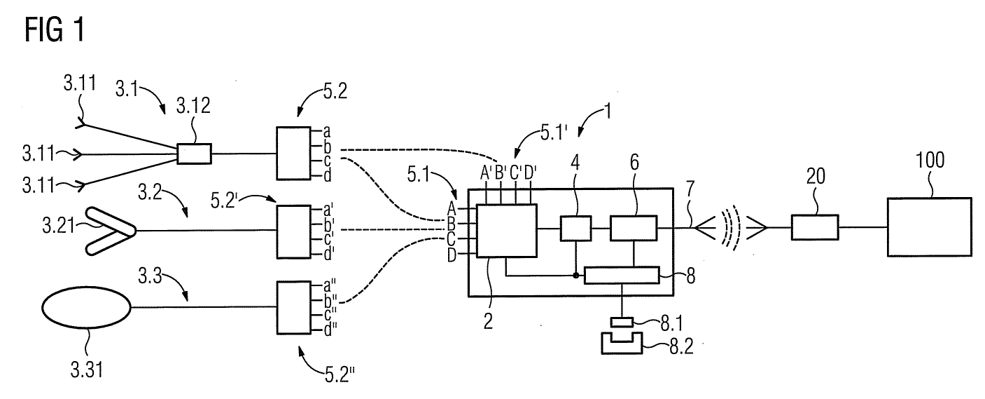

FIG. 1 shows a schematic diagram of an inventive measurement facility, which comprises one further processing unit 1 as well as at least one sensor unit 3.1, 3.2, 3.3. The sensor unit 3.1, 3.2, 3.3 can be connected in this case via an interface 5.1, 5.1′ of the further processing unit, in order to form a usable inventive measurement facility. The measurement facility is deemed to be usable here if signals measured by the sensor unit 3.1, 3.2, 3.3, connected to the further processing unit 1 can be transferred to a supervision unit 20.

The sensor units 3.1, 3.2, 3.3 advantageously each comprise sensors for measuring a physiological variable. This allows the measured data to be used in a support role for imaging or therapy of a patient with a medical therapy/imaging unit.

In the example shown the sensor unit 3.1 comprises three electrodes 3.11, which can be applied for measurement of an EKG signal on a patient (not shown). Where necessary the EKG sensor unit 3.1 also includes a preamplifier 3.12, which pre-amplifies the signals measured by the electrodes 3.11 and possibly also filters them. Naturally EKG sensor units with more or fewer than three electrodes are conceivable.

The sensor unit 3.2. shown in FIG. 1 comprises a pulse sensor for measuring the pulse of a patient (not shown) in the form of a pulse-sensing finger clip 3.21. The further sensor unit 3.3 shown in the diagram comprises a breathing movement sensor 3.31, shown here in the form of pneumogaph, for measuring a breathing movement of a patient (not shown). Pulse-sensing finger clips and pneumogaphs with their associated sensor elements in each case are known in the prior art. Further sensor units for measuring other physiological signals, such as a temperature for example, are conceivable.

The further processing unit 1 comprises at least one filter and/or amplifier unit 2 for filtering und/or amplification of signals received from a connected sensor unit 3.1, 3.2, 3.3.

Where necessary the filtered and/or amplified signals are digitized in a digitization unit 4 of the further processing unit 1 and finally transferred with the aid of a transmit unit 6 of the further processing unit 1 to an evaluation unit 20. The latter can be done in a conventional manner by means of a cable connection, or as shown in FIG. 1 with the aid of an antenna 7 by means of a wireless connection, e.g. a radio connection.

If the further processing unit 1 transmits of the same frequency in each case, regardless of which sensor unit 3.1, 3.2, 3.3 is connected, a further advantage is obtained in that transmit frequencies can be “saved”. Therefore fewer transmit channels have to be blocked for other applications and less radio interference is to be expected. In addition the reception of the radio signals can be simplified in its design on the evaluation unit 20, since no multi-channel reception is necessary.

The evaluation unit 20 evaluates the transferred data and forwards control commands or information via a suitable data connection to a medical therapy/imaging device, which triggers the recording of an image of a patient based on the information received for example.

To supply the further processing unit 1 and its components with energy, the further processing unit 1 includes a power supply unit 8. The power supply unit 8 is embodied for example in the form of a rechargeable battery and is provided with a charge contact 8.1 for charging, via which it can be connected to a charging station 8.2.

Overall the inventive measurement facility synergetically at least partly uses the same signal paths for the different sensor units 3.1, 3.2, 3.3 for filtering, amplification, digitization, power supply and/or transfer to an evaluation unit 10 within the further processing unit 1.

Furthermore the further processing unit 1 contains at least one interface 5.1, 5.1′ via which the further processing unit 1 is able to be connected via a connection point 5.2, 5.2′, 5.2″ of a sensor unit 3.1, 3.2, 3.3 to the sensor unit 3.1, 3.2, 3.3, as indicated by the dashed lines. The interfaces 5.1, 5.1′ in such cases are embodied as analog and/or digital interfaces.

A connection, which can be established with an interface 5.1, 5.1′ and a connection point 5.2, 5.2′, 5.2″, connects the further processing unit 1 and the respective sensor unit 3.1, 3.2, 3.3 not only physically, but also to conduct signals. To this end connection terminals a, b, c, d, a′, b′, c′, d′, a″,b″,c″,d″ of a connection point 5.2, 5.2′, 5.2″ make contact with corresponding connection terminals A,B,C,D, A′,B′,C′,D′ of an interface 5.1, 5.1′. The individual connection terminals a, b, c, d, a′, b′, c′, d′, a″, b″, c″, d″, A, B, C, D, A′, B′, C′, D′ can be embodied optically or electrically in such cases. Pneumatic terminals can also be provided.

Advantageously the connection terminals a, b, c, d, a′, b′, c′, d′, a″,b″,c″,d″, A, B, C, D, A′,B′,C′,D′ are specifically assigned for different sensor units. For example for a connection to interface 5.1 for the sensor unit 3.1 only the connection terminals a, b and c, which contact the connection terminals A, B and C, could be occupied, for sensor unit 3.2 however connection terminals b′, c′ and d′, which contact connection terminals B, C and D and for sensor unit 3.3 e.g. only the connection terminals a and d, which contact connection terminals A and D.

It can thus be advantageously automatically established which sensor unit 3.1,3.2,3.3 is currently connected to the further processing unit 1.

It is further conceivable for individual connection terminals A, B, C, D, A′, B′, C′, D′ of an interface 5.1, 5.1′ to each be reserved only for a particular sensor unit 3.1, 3.2, 3.3 and thus for example to be only able to be contacted at all for a certain sensor unit 3.1, 3.2, 3.3.

Advantageously the further processing unit 1 includes more than one interface 5.1, 5.1′, so that a number of sensor units 3.1, 3.2, 3.3 can also be connected simultaneously with the further processing unit. Here too at least two different sensor units 3.1, 3.2, 3.3 can advantageously continue to be connected to the further processing unit 1 at one of the number of interfaces 5.1, 5.1′.

In one embodiment the medical therapy imaging device 100 is a magnetic resonance device. In this case the sensor units 3.1, 3.2, 3.3 are embodied MR-compatible, i.e. they are embodied such that they do not interact in a negative fashion with electromagnetic field of the magnetic resonance device 100. To this end the sensor units 3.1, 3.2, 3.3 typically do not contain any magnetic materials and are screened if necessary. Advantageously the further processing unit 1 is also embodied MR-compatible in the same way.

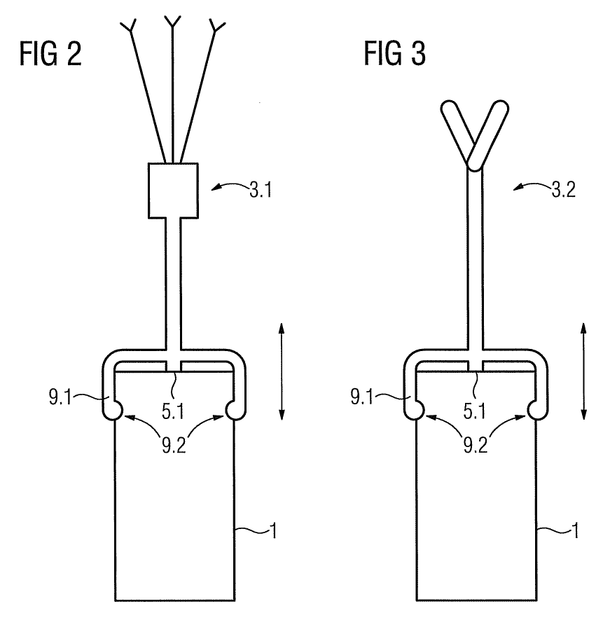

FIG. 2 shows a schematic diagram of a further processing unit 1 connected to a sensor unit 3.1 for measuring EKG signals. In this figure the sensor unit 3.1 is fixed by way of fixing means 9.1 to the further processing unit 1, to ensure a connection between the two units at the interface 5.1. In this case projections 9.1 included in the sensor unit 3.1 engage on connection of the sensor unit 3.1 with the further processing unit 1 into recesses 9.2 on the outside of the further processing unit 1. This fixing can be released again by lifting the projections 9.1 out of the recesses 9.2 and the sensor unit 3.1 can be separated from the further processing unit 1. Subsequently for example a sensor unit 3.2 can be connected in the same way to the further processing unit 1. This situation is shown in FIG. 3.

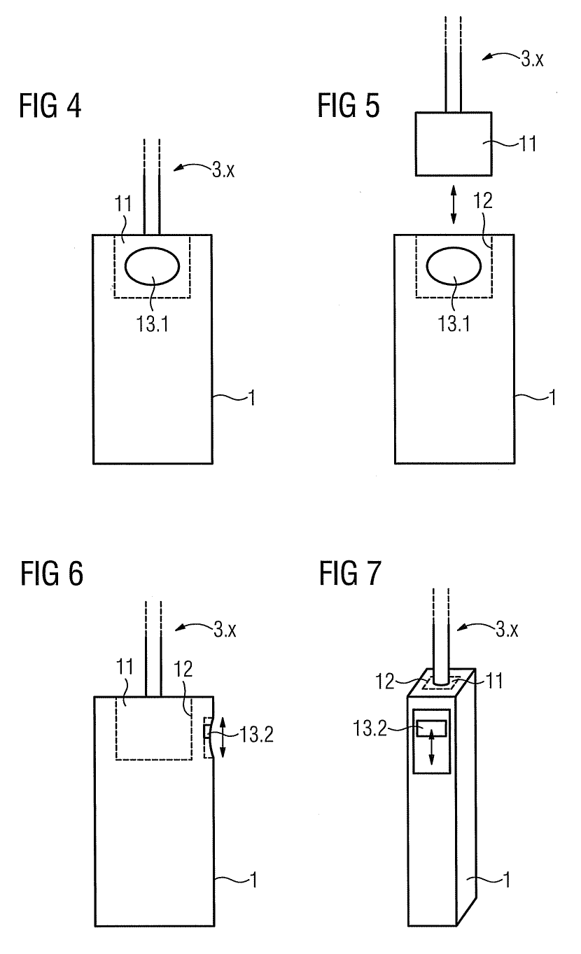

An alternate means of fixing is illustrated with reference to FIGS. 4 and 5. Here the sensor unit 3.x (only shown in section) is a shaped section 11 able to be sunk into a hollowed-out part 12 of the further processing unit 1, which can be fixed detachably into the hollowed-out section 12, e.g. by latching onto a lock. With this solution advantageously no parts of the sensor unit 3.x or the fixing means protrude. The fixing can for example be released again by means of a release button 13.1 arranged on the side wall of the further processing unit 1. Such locks and release buttons 13.1 are known.

FIGS. 6 and 7 show two views of a further embodiment of the fixing means which is very similar to that shown in FIGS. 4 and 5. Here however, instead of a release button a slider switch 13.2 is provided to release the lock, which is advantageously sunk into the further processing unit 1, in order to reduce the danger of it being left hanging on the slider switch 13.2. The slider switch 13.2 is also advantageously arranged on a narrow side of the further processing unit 1, in order to reduce the danger of an accidental release. Furthermore the arrangement on a narrow side is of advantage because the further processing unit 1 does not as a rule rest on such a narrow side and thus a mechanical strain on the slider switch 13.2 from it lying underneath the further processing unit 1 is avoided.

1.-20. (canceled)

21. A measurement device, comprising:
a sensor unit that measures a signal and issues the signal;
a further processing unit that receives the signal and further processes the signal; and
an interface that detachably connects the further processing unit to the sensor unit.

22. The measurement device as claimed in claim 21, wherein the interface comprises a connection terminal that is selected from the group consisting of: an optical connection terminal, an electrical connection terminal, and a pneumatic connection terminal.

23. The measurement device as claimed in claim 22, wherein the connection terminal is specifically assigned to the sensor unit.

24. The measurement device as claimed in claim 21, wherein the interface is an analog or a digital interface.

25. The measurement device as claimed in claim 21, further comprising a plurality of interfaces.

26. The measurement device as claimed in claim 21, wherein the measurement device is MR-compatible.

27. The measurement device as claimed in claim 21, further comprising a fixing unit for fixing the connection between the sensor unit and the further processing unit.

28. The measurement device as claimed in claim 27, wherein the fixing unit fits a part of the sensor unit with the further processing unit.

29. The measurement device as claimed in claim 28, wherein the fixing unit comprises a projection that engages into a recess on an outside of the further processing unit.

30. The measurement device as claimed in claim 28, wherein the fixing unit comprises a piece sunk into a hollowed-out section of the further processing unit that can be detachably fixed with a retaining device of the further processing unit into the hollowed-out section.

31. The measurement device as claimed in claim 30, wherein the retaining device comprises a release mechanism that is able to be actuated on the outside of the further processing unit.

32. The measurement device as claimed in claim 21, wherein the sensor unit measures a physiological signal.

33. The measurement device as claimed in claim 21, wherein the sensor unit comprises an EKG electrode that measures an EKG signal.

34. The measurement device as claimed in claim 21, wherein the sensor unit comprises a pulse sensor that measures a pulse.

35. The measurement device as claimed in claim 21, wherein the sensor unit comprises a breathing movement sensor that measures a breathing movement.

36. The measurement device as claimed in claim 21, wherein the further processing unit comprises:
a filter unit that filters the signal received from the sensor unit, or
an amplifier unit that amplifies the signal received from the sensor unit, or
a digitization unit that digitizes the signal received from the sensor unit, or
a radio transmit unit that sends out the signal received from the sensor unit, or
a power supply unit.

37. A further processing unit of a measurement device, comprising:
an interface that provides a detachable connection between the further processing unit and a sensor unit of the measurement device.

38. The further processing unit as claimed in claim 37, wherein the further processing unit is MR-compatible.

39. A sensor unit of a measurement device, comprising:
a connection point that provides a detachable connection between a further processing unit of the measurement device and the sensor unit.

40. The sensor unit as claimed in claim 39, wherein the sensor unit is MR compatible.
